(19) United States
(12) Patent Application Publication
(10) Pub. No.: US 2019/0248364 A1
(43) Pub. Date: Aug. 15, 2019

(54) METHODS AND SYSTEMS FOR ROAD HAZARD DETECTION AND LOCALIZATION

(71) Applicant: GM GLOBAL TECHNOLOGY OPERATIONS LLC, Detroit, MI (US)

(72) Inventors: Rana Dastgir, Toronto (CA); Shiv G. Patel, Toronto (CA); Ryan J. Benoit, Bowmanville (CA); Norman J. Weigert, Whitby (CA)

(73) Assignee: GM GLOBAL TECHNOLOGY OPERATIONS LLC, Detroit, MI (US)

(21) Appl. No.: 15/894,501

(22) Filed: Feb. 12, 2018

(51) Int. Cl. B60W 30/08; G05D 1/00; B60W 10/20; B60W 10/18; B60W 10/04

(52) U.S. Cl. CPC B60W 30/08; G05D 1/0088; B60W 10/20; B60W 10/18; B60W 2600/00; B60W 2550/14; B60W 2550/408; B60W 2710/20; B60W 2710/18; B60W 10/04

(57) ABSTRACT

Methods and systems are provided for controlling a vehicle. In one embodiment, a method includes: receiving, by a processor, sensor data indicative of conditions of a roadway in a path of a first vehicle; determining, by a processor, road hazard information based on the presence of a road hazard within the roadway; assigning, by a processor, a category to the road hazard information; selectively communicating, by a processor, the road hazard information to a second vehicle based on vehicle information associated with the second vehicle and the category; and selectively, by a processor, controlling the second vehicle based on the vehicle information.

### TECHNICAL FIELD

The technical field generally relates to vehicles, and more particularly to methods and systems for detecting potholes and/or other road hazards and controlling the vehicle and the sharing of information based thereon.

### INTRODUCTION

A road surface in some cases includes one or more road hazards such as, but no limited to, potholes, speed bumps, debris, or other objects. Hitting such road hazards when traveling along the road may be unpleasant to a vehicle occupant and may even cause damage to the vehicle.

Vehicle sensors have been used to detect potholes and other road hazards. Such detection typically does not occur in time to prevent the vehicle from hitting the hazard rather, provides information useful in preventing other vehicles from hitting the hazard through, for example, crowd sourcing. Such information does not always include an accurate location of the road hazard. Such information is not always shared with the correct vehicles.

Accordingly, it is desirable to provide improved methods and systems for detecting upcoming hazards in the road and controlling the vehicle based thereon. It is further desirable to provide improved methods and systems for sharing information about the detecting upcoming hazards with other vehicles. Furthermore, other desirable features and characteristics will become apparent from the subsequent detailed description and the appended claims, taken in conjunction with the accompanying drawings and the foregoing technical field and background.

### SUMMARY

Methods and systems are provided for controlling a vehicle. In one embodiment, the method includes: receiving, by a processor, sensor data indicative of conditions of a roadway in a path of a first vehicle; determining, by a processor, road hazard information based on the presence of a road hazard within the roadway; assigning, by a processor, a category to the road hazard information; selectively communicating, by a processor, the road hazard information to a second vehicle based on vehicle information associated with the second vehicle and the category; and selectively controlling, by a processor, the second vehicle based on the vehicle information.

In various embodiments, the selectively controlling the second vehicle includes controlling the vehicle autonomously or with user input based on at least one of the hazard level category and the road hazard information. In various embodiments, the selectively communicating is based on a lane location of the road hazard and a lane location of the second vehicle. In various embodiments, the category is a vehicle category.

In various embodiments, the assigning the vehicle category is based on an evaluation of a hazard level. In various embodiments, the vehicle category is defined based on at least one of a tire size, a tire profile, vehicle weight, a ground clearance, and a vehicle speed.

In various embodiments, the method further includes receiving the vehicle information from the second vehicle, and wherein the vehicle information includes at least one of a tire size, a tire profile, vehicle weight, a ground clearance, and a vehicle speed.

In various embodiments, the second vehicle includes different wheels; the vehicle information is based on a smallest size (in terms of tire height or profile which essentially is the amount of rubber that can absorb the energy due to impact) of the different wheels.

In another embodiment, a system includes: at least one sensor that generates sensor signals based on conditions of a roadway in a path of the vehicle; and at least one non-transitory computer module that, by at least one processor, receives the sensor signals, determines road hazard information based on the presence of a road hazard within the roadway, assigns a category to the road hazard information, selectively communicates the road hazard information to a second vehicle based on vehicle information associated with the second vehicle and the category, and selectively controls the second vehicle based on the vehicle information.

In various embodiments, the category is a hazard level category. In various embodiments, the at least one non-transitory computer module assigns the hazard level category based an evaluation of at least one of a depth, an angle of an exiting wall, a height, a length, and a width of the road hazard.

In various embodiments, the at least one non-transitory computer module controls the second vehicle by controlling the vehicle autonomously or with user input based on at least one of the hazard level category and the road hazard information.

In various embodiments, the at least one non-transitory computer module selectively communicates based on a lane location of the road hazard and a lane location of the second vehicle. In various embodiments, the category is a vehicle category.

In various embodiments, the at least one non-transitory computer module assigns the vehicle category based on an evaluation of a hazard level.

In various embodiments, the vehicle category is defined based on at least one of a tire size, a tire profile, vehicle weight, a ground clearance, and a vehicle speed.

In various embodiments, the at least one non-transitory computer module receives the vehicle information from the second vehicle, and wherein the vehicle information includes at least one of a tire size, a tire profile, vehicle weight, a ground clearance, and a vehicle speed.

In various embodiments, when the second vehicle includes different wheels, the vehicle information is based on a smallest size of the different wheels.

### DESCRIPTION OF THE DRAWINGS

The exemplary embodiments will hereinafter be described in conjunction with the following drawing figures, wherein like numerals denote like elements, and wherein:

FIG. 1 is a functional block diagram of an exemplary vehicle having a embodied thereon a road hazard vehicle control system, in accordance with various embodiments;

FIG. 2 is an illustration of exemplary vehicles of FIG. 1 traveling on a roadway, in accordance with various embodiments;

FIGS. 3, 4, and 5 are flowcharts illustrating methods for controlling the vehicles in accordance with various embodiments;

FIG. 6 is an illustration of exemplary hazard categories in accordance with various embodiments; and

FIG. 7 is an illustration of exemplary vehicle categories in accordance with various embodiments.

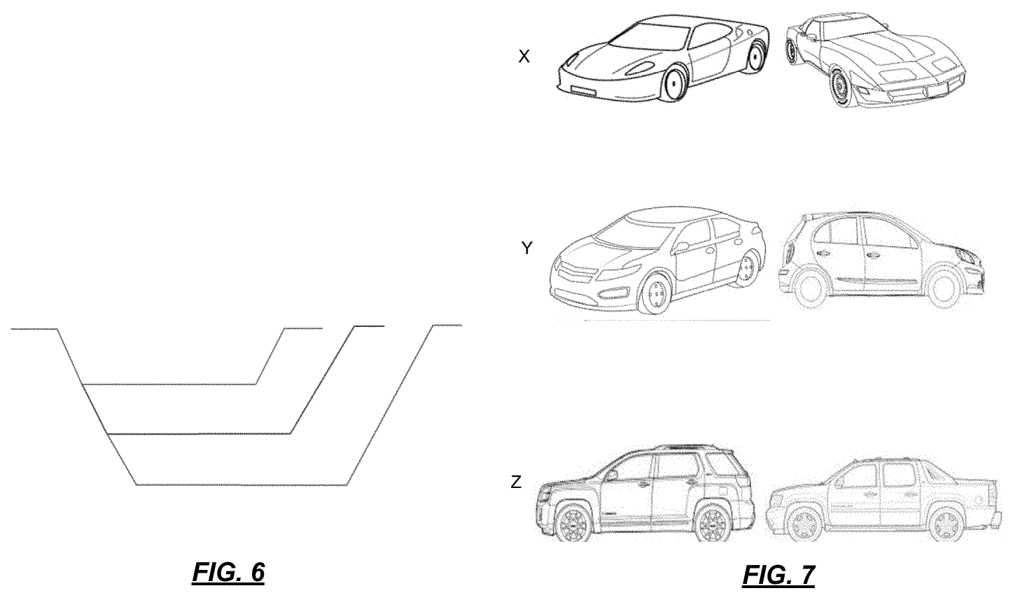

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Exemplary embodiments may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that exemplary embodiments may be practiced in conjunction with any number of control systems, and that the vehicle system described herein is merely one example embodiment.

For the sake of brevity, techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an exemplary embodiment.

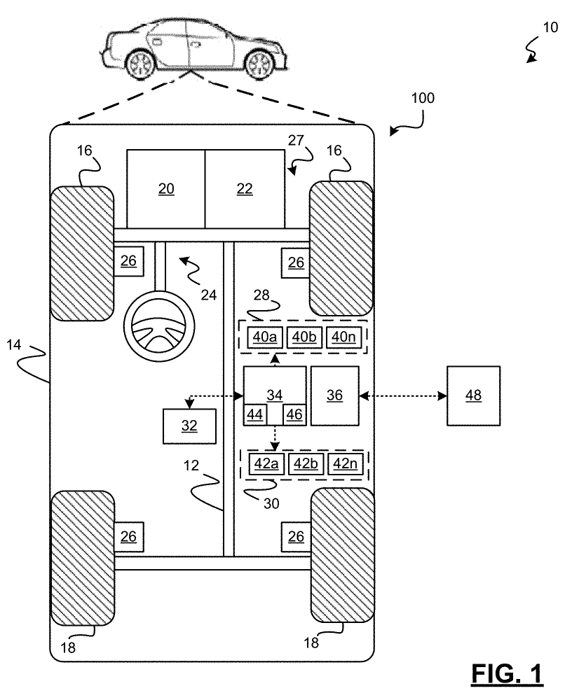

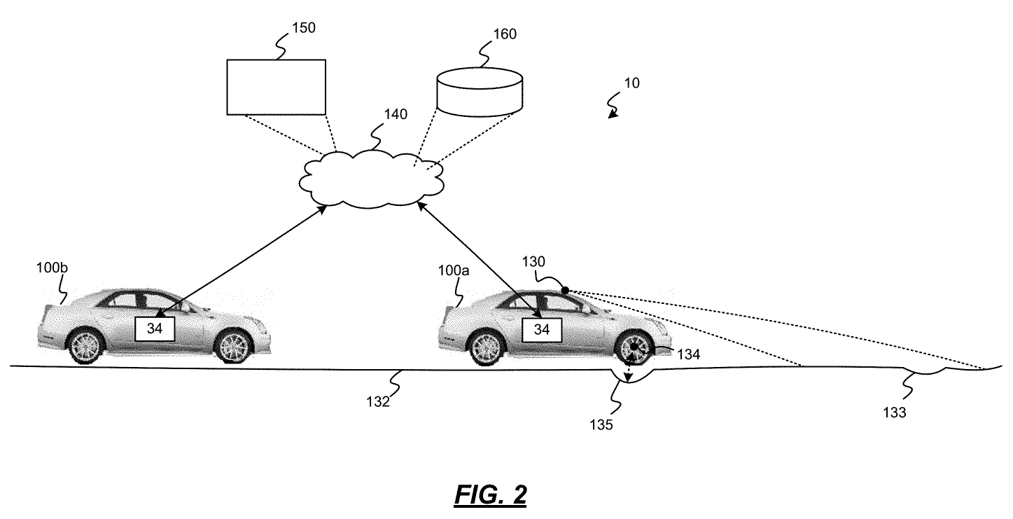

With reference to FIGS. 1 and 2, an exemplary road hazard vehicle control system 10 is shown to be associated with one or more vehicles 100 in accordance with exemplary embodiments. As can be appreciated, the vehicles 100 may be any vehicle type that travels over a road surface such as but not limited to, an automobile, a bicycle, a utility vehicle, etc. Although the figures shown herein depict an example with certain arrangements of elements, additional intervening elements, devices, features, or components may be present in actual embodiments.

In various embodiments, one or more of the vehicles 100 is an autonomous vehicle. In various embodiments, the vehicle 100a is an autonomous vehicle and the system 10 is incorporated in part or in full into the autonomous vehicle 100a. The autonomous vehicle 100a is, for example, a vehicle that is automatically controlled to carry passengers from one location to another. The vehicle 100a is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the autonomous vehicle 100a is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown in more detail in FIG. 1, the autonomous vehicle 100 generally includes a propulsion system 20, a transmission system 22, a steering system 24, a brake system 26, a suspension system 27, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (“V2V” communication,) infrastructure (“V2I” communication), remote computing systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a 5 g or dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The sensor system 28 includes one or more sensing devices 40a-40n that sense observable conditions of the exterior environment and/or the interior environment of the autonomous vehicle 10, and/or other vehicle conditions. In various embodiments, the sensing devices 40a-40n that sense the environment can include, but are not limited to, radars, lidars, global positioning systems, optical cameras, thermal cameras, ultrasonic sensors, and/or other sensors. For example, as shown in more detail in FIG. 2, a sensing device 130 senses conditions associated with a roadway 132 along the vehicle's path (in front of the vehicle 100a, behind the vehicle 100a, to the sides of the vehicle 100a, etc.) and generate sensor data based thereon. Such conditions may include, but are not limited to, elevation changes of a surface of the roadway 132 with respect to a defined plane. Such elevation changes can be indicative of a depth, an angle of an exiting wall, a height, a length, and/or a width of a road hazard 133. As can be appreciated, a single sensing device 130 or multiple sensing devices 130 can be implemented in various embodiments.

In various embodiments, the sensing devices 40a-40n of FIG. 1 that sense vehicle conditions can include, but are not limited to, impact sensors, height sensors, vibration sensors, etc. For example, as shown in FIG. 2, a sensing device 134 senses the vehicle's response to interaction with a road hazard 135. As can be appreciated, a single sensing device 134 or multiple sensing devices 134 can be implemented in various embodiments

With reference back to FIG. 1, in various embodiments, the sensing devices 40a-40n communicate sensor signals directly to the controller 34 and/or may communicate the signals to other controllers (not shown) which, in turn, communicate processed data from the signals to the controller 34 over a communication bus (not shown) or other communication means. The actuator system 30 includes one or more actuator devices 42a-42n that control one or more vehicle features such as, but not limited to, the propulsion system 20, the transmission system 22, the steering system 24, the brake system 26, and the suspension system. In various embodiments, the vehicle features can further include interior and/or exterior vehicle features such as, but are not limited to, doors, a trunk, and cabin features such as air, music, lighting, etc. (not numbered).

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 100a.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 100a based on the logic, calculations, methods, and/or algorithms. Although only one controller 34 is shown in FIG. 1, embodiments of the autonomous vehicle 100a can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 100a.

In various embodiments, one or more instructions of the controller 34 are embodied in the system 10 and, when executed by the processor 44, are configured to receive the signals and/or the processed data from the sensing devices 40a-40n and processes the signals and/or data to determine whether a road hazard is present along the path of the vehicle 100a and if so, determine road hazard information. When a road hazard is determined to be present, the instructions are further configured to process additional data such as GPS data and image data to localize the road hazard, and then selectively control the vehicle 100a based on the location of the road hazard and the location of the vehicle 100a. For example, the controller 34 controls the suspension system 27, for example, by adjusting ride stiffness, height, and active air dams based on the location of the road hazard. In another example, controller 34 generates notifications to a driver based on the road hazard.

In various embodiments, the road hazard vehicle control system 10 further includes a cloud computing system 140. The cloud computing system 140 can be remote from the vehicles 100, such as, but not limited to, a server system or other system as shown and/or may be incorporated into the vehicles 100. In various embodiments, the controller 34 communicates road hazard information including the identified road hazard and the location to the cloud computing system 140 via, for example the communication system 36 (FIG. 1). The cloud computing system 140 includes a data management module 150 and a datastore 160. The data management module 150, in turn, receives the road hazard information, selectively categorizes the road hazard information, and stores the categorized road hazard information in the datastore 160.

The data management module 150 further receives vehicle information from other vehicles 100b and selectively communicates the stored, categorized road hazard information to the other vehicles 100b based on the received vehicle information. For example, the data management module 150 selectively communicates the road hazard information to other vehicles 100b associated with an immediate or near immediate threat of the road hazard. In another example, the data management module 150 selectively communicates the road hazard information to other vehicles 100b based on a determined impact of the road hazard on the other vehicle 100b.

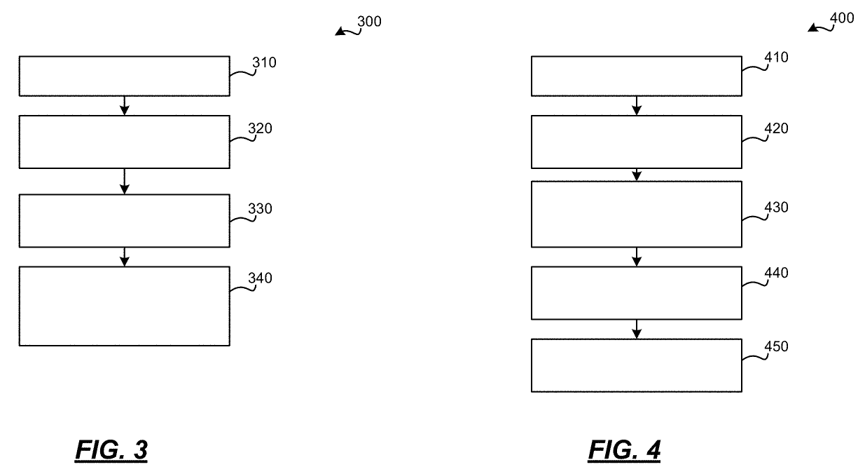

With reference now to FIGS. 3, 4, and 5, flowcharts illustrate more detailed methods 300, 400, and 500 for managing road hazard information and controlling the vehicle 100 based thereon. The methods 300, 400 and 500 can be implemented in connection with the vehicles 100 and the cloud computing system 140 of FIG. 1, in accordance with various exemplary embodiments. As can be appreciated in light of the disclosure, the order of operation within the methods is not limited to the sequential execution as illustrated in FIGS. 3-5, but may be performed in one or more varying orders as applicable and in accordance with the present disclosure. As can further be appreciated, the methods 300, 400, 500 may be enabled to run continuously, may be scheduled to run at predetermined time intervals during operation of the vehicle 100 and/or may be scheduled to run based on predetermined events.

With initial reference to FIG. 3, the illustrated method 300 may be performed by the data management module 150 of FIG. 2 to categorize road hazard information. For example, road hazard information is received at 310. In various embodiments the road hazard information includes the depth, the angle of the exiting wall, the height, the length, the width, and the geographic location of the road hazard as determined by the sensing devices 40a-40n and/or the controller 34. In various embodiments, the road hazard information includes vehicle response data as determined by the sensing devices 40a-40n and/or the controller 34.

A hazard category is then selected from a plurality of defined hazard categories based on the received road hazard information at 320. For example, as illustrated in FIG. 5, road hazard categories labeled A, B, C, etc. may be defined for ranges of or specific values for depths, angles of the exiting wall, heights, lengths, widths, etc. The hazard category is selected from the defined hazard categories A, B, C based on the received depth, angle of the exiting wall, height, length, width by direct comparison and/or interpolation.

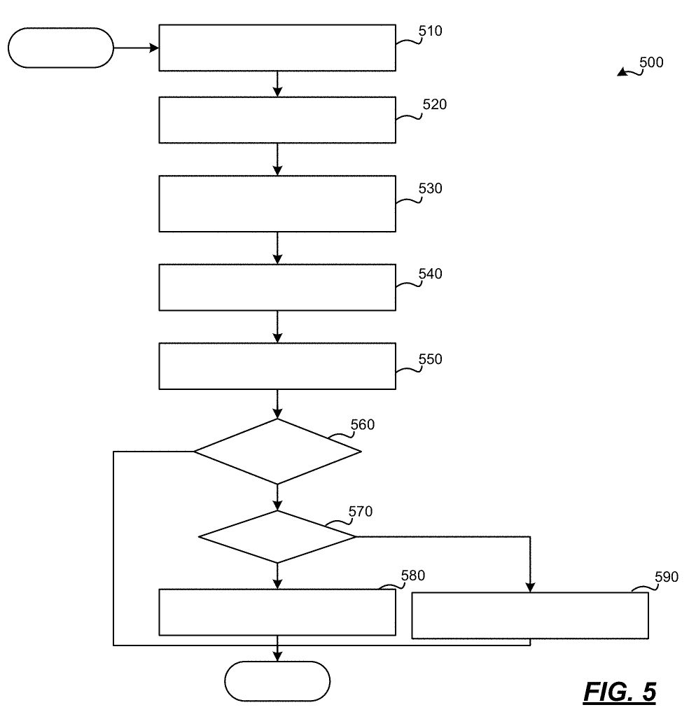

A vehicle category is then assigned from a plurality of vehicle categories based on the hazard category at 330. For example, as illustrated in FIG. 6, vehicle categories labeled, X, Y, Z, etc. may be defined for ranges of or specific values for vehicles having a tire size, tire profile, weight, ground clearance, speed, etc. and may be associated with different road hazard categories. The vehicle categories may also be based on a trailer being associated with the vehicle and the corresponding trailer a tire size, tire profile, weight, ground clearance, speed, etc. The vehicle category is assigned from one of the defined vehicle categories based on the selected hazard category by direct comparison and/or interpolation. As can be appreciated, one or more vehicle categories may be assigned to any one road hazard. The road hazard category, vehicle category, and road hazard location are then stored with the road hazard information in the datastore 160 at 340.

With reference now to FIG. 4, the illustrated method may be performed by the data management module 150 to selectively communicate the stored road hazard information. For example, vehicle information is received at 410. The vehicle information can include, but is not limited to, a tire size, a tire profile, a weight, a round clearance, a speed, and a location of the vehicle. In various embodiments, when a vehicle 100 includes more than one wheel and the wheels have different size or a trailer and a vehicle have different wheel sizes, the information for the smallest wheel is used. In various embodiments, other parameters associated with the trailer may be used in addition to or as an alternative to the wheel size.

The stored data in the datastore 160 is processed along with the current location and road map data to select road hazards that have a location that fall within the lane of travel of the vehicle 100 at 420. The current vehicle category is determined based on the received tire size, tire profile, weight, ground clearance, and speed at 430. The road hazards selected based on location and then filtered based on the current vehicle category at 440. The filtered road hazard and the corresponding information are then communicated back to the vehicle at 450.

With reference now to FIG. 5, the illustrated method 500 may be performed by the road hazard vehicle control system 10 to detect road hazards and control one or more vehicles based on the detected road hazards. For example, data is received from one or more sensing devices and a road hazard is detected at 510. The detected road hazard is then localized based on data from the sensing devices and/or GPS data at 520. The road hazard information is then communicated to the remote computing system at 530 where it is categorized and stored at 540. The stored road hazard information is then selectively communicated to one or more vehicles based on received vehicle information and the categories at 550. And when it is determined that the receiving vehicle is approaching the road hazard at 560, it is determined if the road hazard is too big based on the category at 570. If the road hazard is not too big at 570, the vehicle is autonomously controlled for example to adjust the suspension such that any vehicle damage or occupant discomfort is reduced or avoided at 590. If the road hazard is too big at 570, the vehicle is controlled for example to adjust the suspension, selectively maneuver around the vehicle (e.g., by changing lanes, or moving within the lane), reduce speed, and or to generate notifications to occupants of the vehicle of the upcoming road hazard such that vehicle damage or occupant discomfort is reduced or avoided at 580. Thereafter, the method may end.

While at least one exemplary embodiment has been presented in the foregoing detailed description, it should be appreciated that a vast number of variations exist. It should also be appreciated that exemplary embodiments are only examples, and are not intended to limit the scope, applicability, or configuration of the disclosure in any way. Rather, the foregoing detailed description will provide those skilled in the art with a convenient road map for implementing the exemplary embodiments. It should be understood that various changes can be made in the function and arrangement of elements without departing from the scope of the disclosure as set forth in the appended claims and the legal equivalents thereof.

What is claimed is:

1. A method for controlling a vehicle, comprising:
receiving, by a processor, sensor data indicative of conditions of a roadway in a path of a first vehicle;
determining, by a processor, road hazard information based on the presence of a road hazard within the roadway;
assigning, by a processor, a category to the road hazard information;
selectively communicating, by a processor, the road hazard information to a second vehicle based on vehicle information associated with the second vehicle and the category; and
selectively controlling, by a processor, the second vehicle based on the vehicle information.

2. The method of claim 1, wherein the category is a hazard level category.

3. The method of claim 2, wherein the assigning the hazard level category is based an evaluation of at least one of a depth, an angle of an exiting wall, a height, a length, and a width of the road hazard.

4. The method of claim 2, wherein the selectively controlling the second vehicle comprises controlling the vehicle autonomously or with user input based on at least one of the hazard level category and the road hazard information.

5. The method of claim 1, wherein the selectively communicating is based on a lane location of the road hazard and a lane location of the second vehicle.

6. The method of claim 1, wherein the category is a vehicle category.

7. The method of claim 6, wherein the assigning the vehicle category is based on an evaluation of a hazard level.

8. The method of claim 6, wherein the vehicle category is defined based on at least one of a tire size, a tire profile, vehicle weight, a ground clearance, and a vehicle speed.

9. The method of claim 1, further comprising receiving the vehicle information from the second vehicle, and wherein the vehicle information includes at least one of a tire size, a tire profile, vehicle weight, a ground clearance, and a vehicle speed.

10. The method of claim 9, wherein when the second vehicle includes different wheels, the vehicle information is based on a smallest size of the different wheels.

11. A system for controlling a vehicle, comprising:
at least one sensor that generates sensor signals based on conditions of a roadway in a path of the vehicle; and
at least one non-transitory computer module that, by at least one processor, receives the sensor signals, determines road hazard information based on the presence of a road hazard within the roadway, assigns a category to the road hazard information, selectively communicates the road hazard information to a second vehicle based on vehicle information associated with the second vehicle and the category, and selectively controls the second vehicle based on the vehicle information.

12. The system of claim 11, wherein the category is a hazard level category.

13. The system of claim 12, wherein the at least one non-transitory computer module assigns the hazard level category based an evaluation of at least one of a depth, an angle of an exiting wall, a height, a length, and a width of the road hazard.

14. The system of claim 12, wherein the at least one non-transitory computer module controls the second vehicle by controlling the vehicle autonomously or with user input based on at least one of the hazard level category and the road hazard information.

15. The system of claim 12, wherein the at least one non-transitory computer module selectively communicates based on a lane location of the road hazard and a lane location of the second vehicle.

16. The system of claim 11, wherein the category is a vehicle category.

17. The system of claim 16, wherein the at least one non-transitory computer module assigns the vehicle category based on an evaluation of a hazard level.

18. The system of claim 16, wherein the vehicle category is defined based on at least one of a tire size, a tire profile, vehicle weight, a ground clearance, and a vehicle speed.

19. The system of claim 11, wherein the at least one non-transitory computer module receives the vehicle information from the second vehicle, and wherein the vehicle information includes at least one of a tire size, a tire profile, vehicle weight, a ground clearance, and a vehicle speed.

20. The system of claim 19, wherein when the second vehicle includes different wheels, the vehicle information is based on a smallest size of the different wheels.
